(19) United States
(12) Patent Application Publication
(10) Pub. No.: US 2025/0388044 A1
(43) Pub. Date: Dec. 25, 2025

(54) FIBER SPOKE AND WHEEL

(71) Applicant: Xiamen Baiyexing Outdoor Products Co., Ltd., Xiamen (CN)

(72) Inventor: Jinji YE, Xiamen (CN)

(21) Appl. No.: 19/194,727

(22) Filed: Apr. 30, 2025

(30) Foreign Application Priority Data
Jun. 20, 2024 (CN) 202421422299.5

(51) Int. Cl. B60B 1/02

(52) U.S. Cl. CPC B60B 1/0261

(57) ABSTRACT

The present invention provides a fiber spoke, including a spoke body. The spoke body includes a windward part, a tail, and two side surfaces connected between the windward part and the tail. The windward part is provided with a first wave structure, and the two side surfaces are provided with a second wave structure. A flat axle shape design of the spoke body, combined with the wave structure, can significantly reduce the wind resistance of the spoke, thereby reducing the overall wind resistance of the wheel assembly and reducing the tension loss of the spoke after tire inflation.

### CROSS-REFERENCE TO RELATED APPLICATION

This application claims priority to China Patent Application 202421422299.5, filed Jun. 20, 2024, which is incorporated herein by reference.

### TECHNICAL FIELD

The present invention relates to the technical field of wheel accessories, specifically to a fiber spoke and a wheel.

### BACKGROUND

Spokes are commonly used vehicle accessories for connecting the rim and the hub, and are especially widely used in small motor vehicles such as bicycles and motorcycles. The main body of a conventional spoke is a long straight strip with a circular or flat cross-section. The spoke features high rigidity and a simple manufacturing process, but has some issues. For example, after the wheel assembly is inflated, the tire squeezes the rim inward from the outer side of the rim, creating a hoop-tightening effect on the rim. This causes slight radial deformation of the rim, resulting in significant tension loss in the spoke. Additionally, the overall shock resistance of the wheel assembly is poor.

### SUMMARY

To address at least one of the above issues, the present invention provides a fiber spoke and a wheel.

The present invention is implemented with the following solution:

The present invention provides a fiber spoke, including a spoke body, and a first connecting segment and a second connecting segment that are connected to two ends of the spoke body. The spoke body is in a flat axle shape, the spoke body includes a windward part located at a front end and facing wind, a tapered tail, and two side surfaces connected between the windward part and the tail, the windward part is provided with a first wave structure, and the side surfaces are provided with a second wave structure.

In an embodiment, the first wave structure includes convex parts and concave parts spaced apart alternately and continuously.

In an embodiment, the two side surfaces include a first side surface and a second side surface, the second wave structure includes convex parts and concave parts spaced apart alternately and continuously, and the convex parts on the first side surface are opposite the concave parts on the second side surface, thereby forming an integral wave structure flat and axial between the first side surface and the second side surface.

In an embodiment, a second wave structure is provided on one of the two side surfaces.

The present invention further provides a wheel, including:
multiple fiber spokes, where the fiber spoke includes a spoke body, and a first connecting segment and a second connecting segment that are connected to two ends of the spoke body, the spoke body is in a flat axle shape, the spoke body includes a windward part located at a front end and facing wind, a tapered tail, and two side surfaces connected between the windward part and the tail, the windward part is provided with a first wave structure, and the side surfaces are provided with a second wave structure.
a hub, and
an aerodynamic rim, where the aerodynamic rim includes an outer tire mounting part for mounting a tire, an inner spoke mounting part for mounting spokes, and two rim side walls opposite each other between the outer tire mounting part and the inner spoke mounting part, where the hub is located at a center of the aerodynamic rim, a first end of each fiber spoke is connected to the hub, and a second end of each fiber spoke is connected to the inner spoke mounting part.

In an embodiment, the aerodynamic rim includes multiple aero profiles, and the multiple aero profiles are arranged on the rim side wall and circumferentially surround a center point of the rim.

In an embodiment, the aero profile has an outer contour in an inverted triangle shape, and the inverted triangle has a peak blade in the middle.

In an embodiment, the peak blade is formed by a connection line between a vertex of the inverted triangle and a point on an opposing side of the vertex, and the opposing side is substantially parallel to an outer edge of the rim side wall.

In an embodiment, a surface of the aero profile is provided with at least partially overlapping layered staggered patterns.

In an embodiment, the aero profile is formed by a combination of multiple dimple patterns, and the dimple pattern is a teardrop dimple pattern.

In an embodiment, the aero profile includes a tapered head, an arc-shaped body, and a slender tail that are sequentially connected, and further includes a fin extending outward from the arc-shaped body.

### BRIEF DESCRIPTION OF DRAWINGS

FIG. 1 is a front view of a fiber spoke according to Embodiment 1.

FIG. 2 is an enlarged view of portion A in FIG. 1.

FIG. 3 is a cross-sectional view along H-H in FIG. 2.

FIG. 4 is a side view of the fiber spoke according to Embodiment 1.

FIG. 5 is an enlarged view of portion C in FIG. 4.

FIG. 6 is a front view of a wheel according to Embodiment 2.

FIG. 7 is a cross-sectional view along E-E in FIG. 6.

FIG. 8 is a front view of an aero profile according to Embodiment 2.

FIG. 9 is a view of direction F in FIG. 8 after rotation.

FIG. 10 is a front view of a wheel according to Embodiment 3.

FIG. 11 is a front view of an aero profile according to Embodiment 3.

FIG. 12 is a front view of a wheel according to Embodiment 4.

FIG. 13 is a front view of an aero profile according to Embodiment 4.

FIG. 14 is a front view of a teardrop dimple pattern according to Embodiment 4.

### DESCRIPTION OF EMBODIMENTS

To further illustrate each embodiment, the present invention provides accompanying drawings. These drawings are part of the disclosure of the present invention, primarily used to illustrate the embodiments and, together with the relevant descriptions in the specification, to explain the operating principles of the embodiments. With reference to these contents, a person of ordinary skill in the art can understand other possible implementations and the advantages of the present invention. The components in the drawings are not drawn to scale, and similar component symbols are typically used to represent similar components.

The present invention is now further described with reference to the drawings and specific embodiments.

### Embodiment 1

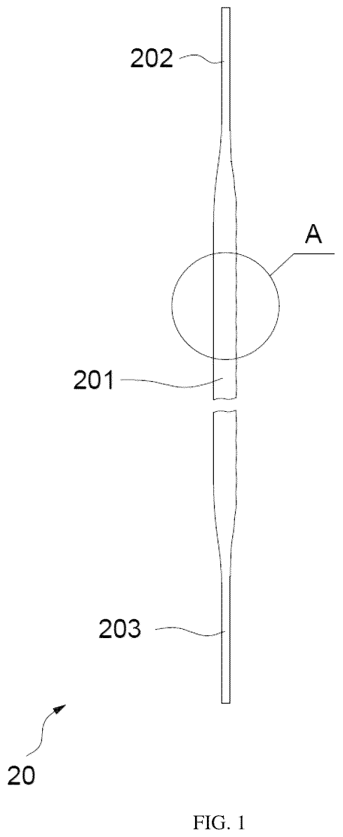

As shown in FIGS. 1 to 5, this embodiment provides a fiber spoke 20, including a spoke body 201, and a first connecting segment 202 and a second connecting segment 203 that are connected to two ends of the spoke body 201. The fiber spoke 20 is made of carbon fiber material. The spoke body 201 is processed into a flat axle shape during the molding and curing process, or preferably, the spoke body 201 is processed into a flat axle shape with a teardrop cross-section during the molding and curing process. The connected first connecting segment 202 and the second connecting segment 203 remain cylindrical in shape, so that the flat axle shape design of the spoke body 201 can be used to significantly reduce the wind resistance of the vehicle.

The first connecting segment 202 and the second connecting segment 203 of the fiber spoke 20 are used to fix connectors, so as to be connected to the aerodynamic rim 10 and the hub 30 respectively via the connectors. Multiple fiber spokes 20 are separately connected to the aerodynamic rim 10 and the hub 30, forming a complete wheel. The connectors used for connection with the rim and the hub may, for example, be a nipple and a cap respectively.

It should be noted that in this embodiment, the fiber spoke 20 being made of carbon fiber material is used as an example for illustration. However, as those skilled in the art can anticipate, using a spoke body made of high-strength, high-modulus fibers of other materials is also a feasible solution. The high-strength, high-modulus fibers refer to high-performance fiber materials defined according to well-known industry standards, specifically synthetic or natural fibers with strength greater than 10 CN/dkex and a modulus greater than 200 CN/dkex.

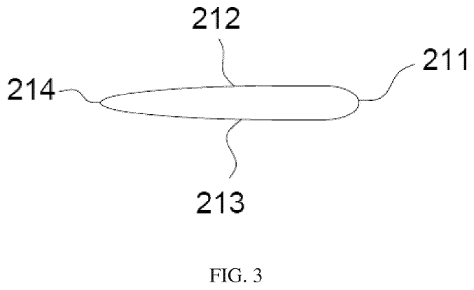

The spoke body 201 of the fiber spoke 20 is in a flat axle shape. Specifically, as shown in FIG. 3, the spoke body 201 includes a windward part 211 located at the front end and facing the wind, a tapered tail 214, and two side surfaces 212 and 213 connected between the windward part 211 and the tapered tail 214. The flat axle shape design of the spoke body 201 can be used to significantly reduce the wind resistance of the vehicle, particularly the teardrop cross-section flat axle shape design, which further reduces wind resistance and provides a better aerodynamic effect.

As shown in FIGS. 1 to 5, the spoke body 201 is provided with a wave structure. The wave structure is specifically described as follows. The flat axle shape design of the spoke body 201, combined with the wave structure, can significantly reduce the wind resistance of the spoke, thereby reducing the overall wind resistance of the wheel assembly.

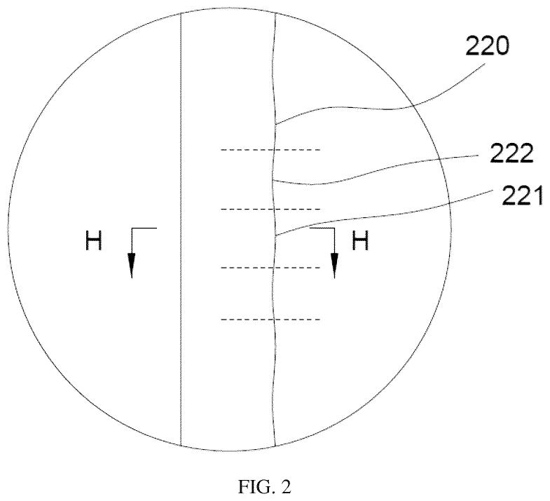

As shown in FIGS. 1 and 2, the windward part 211 is provided with a first wave structure 220. The first wave structure 220 includes convex parts 221 and concave parts 222 spaced apart alternately and continuously (for example, the convex parts 221 and concave parts 222 separated by short dashed lines in FIG. 2). The first wave structure 220 on the windward part 211 of the fiber spoke 20 can reduce the wind resistance experienced by the fiber spoke 20 in the windward direction, thereby reducing the overall wind resistance of the wheel assembly.

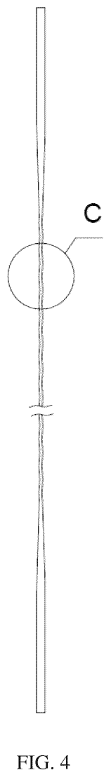

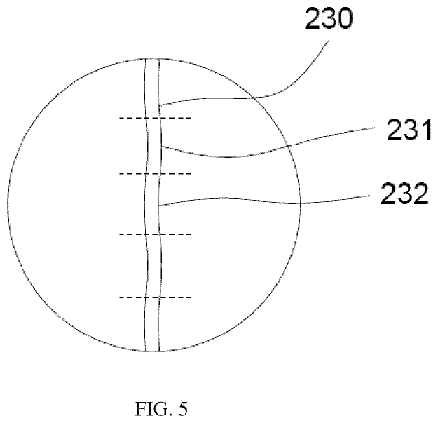

As shown in FIGS. 4 and 5, the two side surfaces 212 and 213 are provided with a second wave structure 230. The second wave structure 230 includes convex parts 231 and concave parts 232 spaced apart alternately and continuously (for example, the convex parts 231 and concave parts 232 separated by short dashed lines in FIG. 2). The second wave structure 230 on the two side surfaces 212 and 213 of the fiber spoke 20 can reduce the lateral wind resistance experienced by the fiber spoke 20, thereby reducing the overall wind resistance of the wheel assembly. Preferably, both side surfaces 212 and 213 are provided with the second wave structure 230. It is easily understood that providing the second wave structure 230 on only one of the side surfaces is also a feasible technical solution. In this embodiment, both side surfaces 212 and 213 are provided with the second wave structure 230, and the convex parts 231 of the second wave structure 230 on the first side surface 212 are opposite the concave parts 232 on the second side surface 213, thereby forming an integral wave structure flat and axial between the first side surface 212 and the second side surface 213. This structure can achieve a better wind resistance reduction effect and can reduce the impact force on the wheel assembly, providing a shock-absorbing effect. Additionally, this structure can reduce the tension loss of the spoke wheel assembly after inflation, making the spoke mounted more stable. More specifically, in a wheel structure with conventional straight spokes, after the tire is inflated, the tire squeezes the rim inward from the outer side of the rim, creating a hoop-tightening effect on the rim. This causes slight radial deformation of the rim, resulting in significant tension loss in the spokes. In this solution, however, after the fiber spoke 20 is tensioned and mounted, the second wave structure 230 deforms due to the tension force generated, and the tensile deformation amount of the fiber spoke 20 with the wave structure is greater than that of the conventional straight spoke. After the tire is inflated, due to the slight radial deformation of the rim, the tensile deformation amount of the fiber spoke 20 slightly decreases, resulting in less tension loss in the fiber spoke 20.

In this embodiment, since the fiber spoke 20 has an overall wave structure (for example, the first wave structure 220 on the windward part 211 of the fiber spoke 20 and the second wave structure 230 on the first side surface 212 and the second side surface 213), after the spokes are mounted to the wheel assembly, the wind resistance of the spokes can be reduced significantly. In addition, when the wheel assembly is subjected to an impact force, the second wave structure 230 of the fiber spoke 20 can provide a certain buffering effect against the impact, reducing the impact force on the wheel assembly and achieving a shock-absorbing effect. Thus, in this embodiment, low wind resistance and impact resistance performance can both be achieved.

It is easily understood that, in other embodiments, it is also a feasible technical solution to provide only the first wave structure 220 or only the second wave structure 230 on the fiber spoke 20.

### Embodiment 2

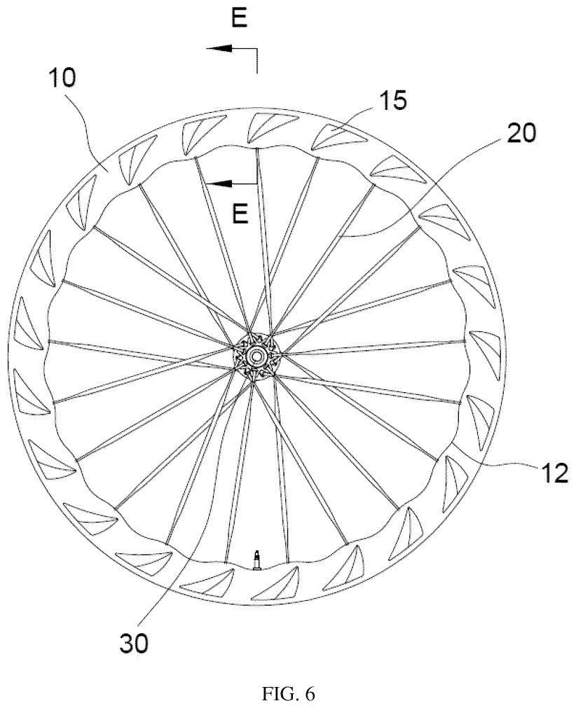

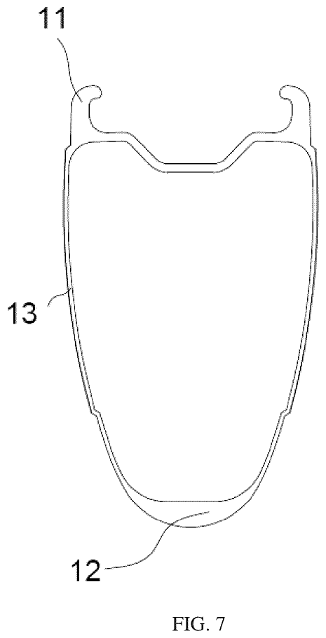

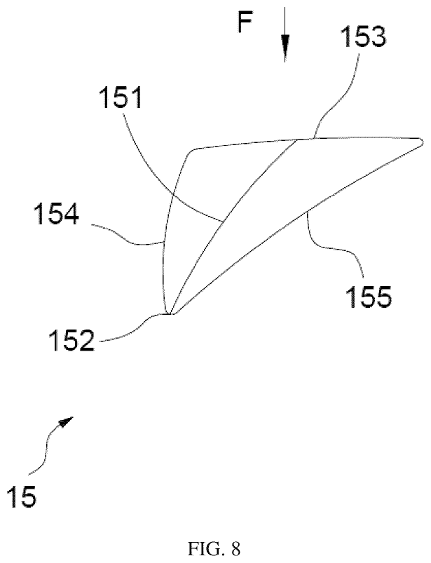

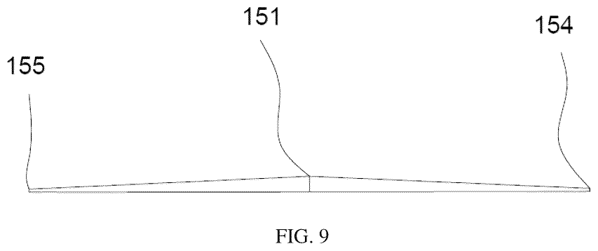

As shown in FIGS. 6 to 9, this embodiment provides a wheel, including multiple fiber spokes 20 as described in the previous embodiment, a hub 30, and an aerodynamic rim 10. The hub 30 is located at a center of the aerodynamic rim 10, a first end of each fiber spoke 20 is connected or integrally formed with the hub 30, and a second end of each fiber spoke 20 is connected or integrally formed with the inner spoke mounting part 12. In this embodiment, preferably, the aerodynamic rim 10 and/or the hub 30 is made of carbon fiber material.

The aerodynamic rim 10, in cooperation with the fiber spoke 20 as described in Embodiment 1, can greatly reduce the wind resistance experienced by the wheel, achieving a better aerodynamic effect.

The aerodynamic rim 10 includes an outer tire mounting part 11 for mounting a tire, an inner spoke mounting part 12 for mounting spokes, and two rim side walls 13 opposite each other between the outer tire mounting part 11 and the inner spoke mounting part 12. The outer tire mounting part 11, the inner spoke mounting part 12, and the two rim side walls 13 enclose a cavity. Preferably, the four are integrally formed and made of carbon fiber material. The aerodynamic rim 10 further includes multiple aero profiles 15, and the multiple aero profiles 15 are arranged on the rim side wall 13 and circumferentially surround the center point of the rim. The aero profile 15 can guide the flow of lateral airflow blowing toward the rim side wall 13, thereby reducing the wind resistance experienced by the rim side wall 13.

Preferably, the aero profiles 15 are circumferentially evenly distributed on the rim side wall 13. The circumferentially evenly distributed aero profiles 15 make the force on the rim more uniform and help reduce wind resistance.

Further, preferably, the aero profiles 15 are arranged on the rim side wall 13 at the extension of each spoke hole, meaning that the number of spoke holes equals the number of aero profiles 15 in the circumferential array. In this way, the aero profile 15 can guide the lateral airflow and correspond to the spoke position, making the airflow guidance smoother and further reducing wind resistance.

As shown in FIGS. 6 to 9, the aero profile 15 is an inverted triangle shape, more specifically an inverted triangle peak shape, where the inverted triangle peak shape means that the outer contour of the aero profile 15 is in an inverted triangle shape, with a peak blade 151 in the middle of the inverted triangle. The peak blade 151 is high, while the two side edges 154 and 155 of the inverted triangle are low, with a transition from the peak blade 151 to the side edges 154 and 155. The peak blade 151 can split the airflow to flow to both sides, thereby reducing the wind resistance experienced by the rim side wall 13.

The peak blade 151 is formed by a connection line between a vertex 152 of the inverted triangle and a point on the opposing side 153 of the vertex 152. Preferably, the peak blade 151 is formed by a connection line between a vertex 152 of the inverted triangle and the midpoint of the opposing side 153 of the vertex 152, and the opposing side 153 is substantially parallel to the outer edge of the rim side wall 13. In this way, the peak blade 151 experiences less wind resistance as the rim rotates, while also reducing the wind resistance experienced by the rim side wall 13.

Preferably, the surface of the inner spoke mounting part 12 has an inner wave pattern with a continuous concave-convex structure, which can cooperate with the aero profile 15 to further reduce wind resistance. Further, the convex parts of the inner wave pattern of the inner spoke mounting part 12 correspond to each spoke hole and also roughly correspond to the vertex 152 of the aero profile 15. In this way, the aero profile 15 can guide the lateral airflow and correspond to the spoke position and the inner wave pattern, making the airflow guidance smoother and integrating the reduction of headwind and sidewind, thereby further reducing wind resistance.

### Embodiment 3

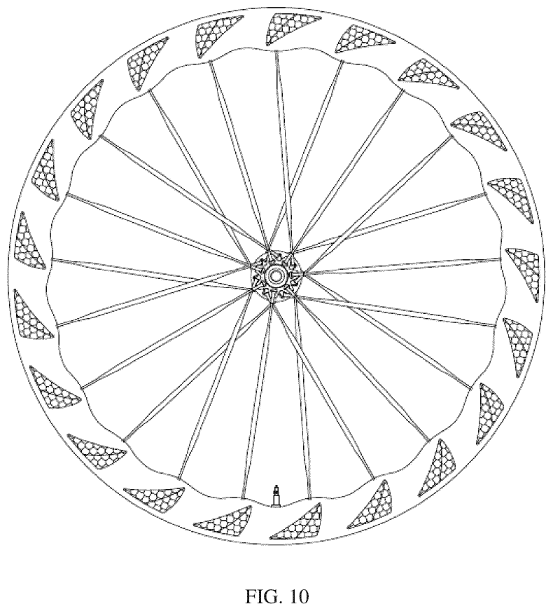

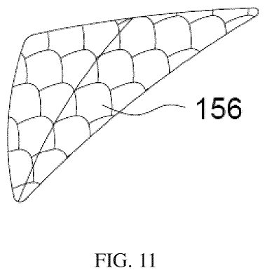

This embodiment is a further improvement based on Embodiment 2. As shown in FIGS. 10 and 11, in this embodiment, the surface of the aero profile 15 is provided with at least partially overlapping layered staggered patterns 156, with the rest being the same as in

Embodiment 2. The at least partially overlapping layered staggered patterns refer to an arrangement structure similar to the dragon scales in traditional Chinese patterns. The at least partially overlapping layered staggered patterns can be used to resist sidewind turbulence, thereby further reducing wind resistance.

### Embodiment 4

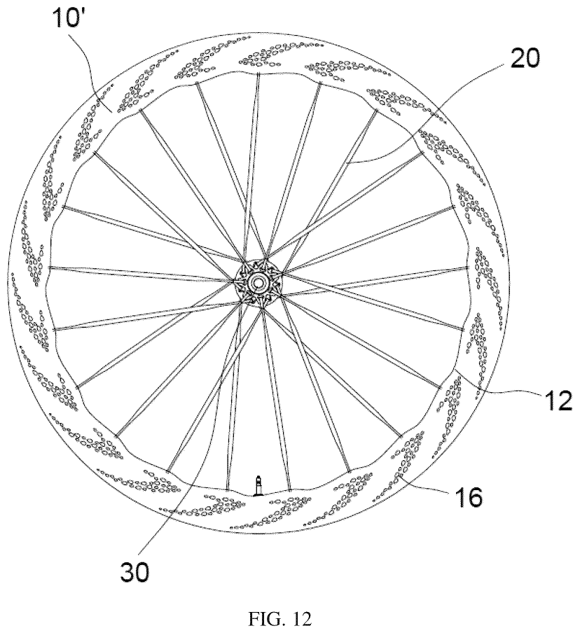

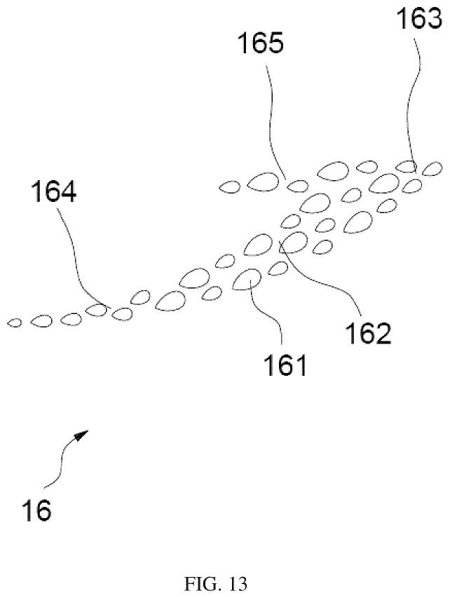

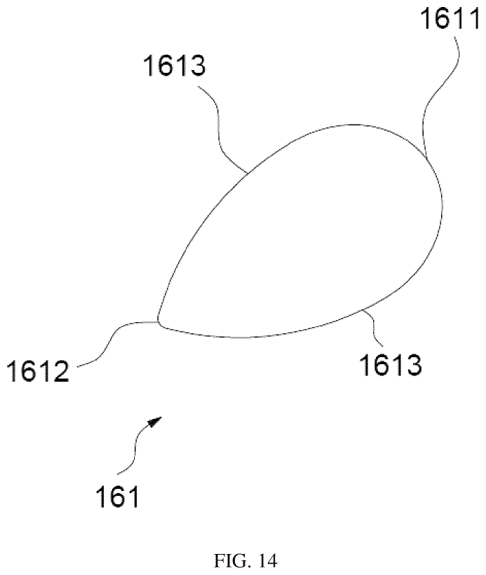

As shown in FIGS. 12 to 14, this embodiment provides an aerodynamic rim 10′. Except for the aero profile of the aerodynamic rim 10′ being different from that in Embodiment 2, the rest is the same as in Embodiment 2. In this embodiment, the aerodynamic rim 10′ includes multiple aero profiles 16, and the multiple aero profiles 16 are arranged on the rim side wall 13 and circumferentially surround the center point of the rim. The aero profile 16 can guide the flow of lateral airflow blowing toward the rim side wall 13, thereby reducing the wind resistance experienced by the rim side wall 13.

The aerodynamic rim 10′, in cooperation with the fiber spoke 20 as described in Embodiment 1, can greatly reduce the wind resistance experienced by the wheel, achieving a better aerodynamic effect.

Preferably, the aero profiles 16 are circumferentially evenly distributed on the rim side wall 13. The circumferentially evenly distributed aero profiles 16 make the force on the rim more uniform and help reduce wind resistance.

Further, preferably, the aero profiles 16 are arranged on the rim side wall 13 at the extension of each spoke hole, meaning that the number of spoke holes equals the number of aero profiles 16 in the circumferential array. In this way, the aero profile 16 can guide the lateral airflow and correspond to the spoke positions, making the airflow guidance smoother and further reducing wind resistance.

As shown in FIGS. 12 to 14, the aero profile 16 is formed by a combination of multiple dimple patterns 161. Based on the principle of dimples on a golf ball surface, the aero profile 16 composed of the multiple dimple patterns 161 reduces the lateral resistance generated during the rotation of the rim.

As shown in FIGS. 12 to 14, the multiple dimple patterns 161 are teardrop dimple patterns 161. The teardrop dimple pattern can further reduce wind resistance.

The teardrop dimple pattern 161 includes a front end 1611, a rear tip 1612, and two side surfaces 1613 connecting the front end 1611 and the rear tip 1612. In this embodiment, the front end 1611 faces the windward direction, enabling the teardrop dimple pattern to achieve the best wind resistance reduction performance.

The entire aero profile 16, being in a swallow shape that is also referred to as a hooked shape, includes a tapered head 163, an arc-shaped body 162, and a slender tail 164 that are connected sequentially, and further includes a fin 165 extending outward from the arc-shaped body 162. The tapered head 163 of the aero profile 16 faces the windward direction, and the extension direction of the slender tail 164 and the fin 165 is opposite to the windward direction.

The side of the rim side wall 13 closer to the center of the rim is defined as the inner side, and the side farther from the center of the rim is defined as the outer side. The slender tail 164 of the aero profile 16 is close to the outer side of the rim side wall 13, and the fin 165 is close to the inner side of the rim side wall 13. The aero profile 16 not only has a good aerodynamic effect but also has an aesthetically pleasing shape, serving a decorative function as well.

Preferably, the surface of the inner spoke mounting part 12 has an inner wave pattern with a continuous concave-convex structure, which can cooperate with the aero profile 16 to further reduce wind resistance. Further, the convex parts of the inner wave pattern of the inner spoke mounting part 12 correspond to each spoke hole and also roughly correspond to the fin 165 of the aero profile 16. In this way, the aero profile 16 can guide the lateral airflow and correspond to the spoke positions and the inner wave pattern, making the airflow guidance smoother and integrating the reduction of headwind and sidewind, thereby further reducing wind resistance.

Although the present invention has been specifically shown and described with reference to preferred embodiments, those skilled in the art should understand that various changes in form and detail can be made to the present invention within the spirit and scope of the present invention as defined by the appended claims, all of which fall within the protection scope of the present invention.

1. A fiber spoke, comprising a spoke body, and a first connecting segment and a second connecting segment that are connected to two ends of the spoke body, wherein the spoke body has a flat axle shape, the spoke body comprises a windward part located at a front end of the spoke body and facing wind, a tapered tail, and two side surfaces connected between the windward part and the tapered tail, the windward part is provided with a first wave structure, and the two side surfaces are provided with a second wave structure.

2. The fiber spoke according to claim 1, wherein the first wave structure comprises convex parts and concave parts spaced apart alternately and continuously.

3. The fiber spoke according to claim 1, wherein the two side surfaces comprise a first side surface and a second side surface, the second wave structure comprises convex parts and concave parts spaced apart alternately and continuously, and the convex parts on the first side surface are opposite the concave parts on the second side surface, thereby forming an integral wave structure that is flat and axial between the first side surface and the second side surface.

4. A wheel, comprising:
multiple fiber spokes, wherein each of the multiple fiber spokes comprises a spoke body, and a first connecting segment and a second connecting segment that are connected to two ends of the spoke body, the spoke body has a flat axle shape, the spoke body comprises a windward part located at a front end of the spoke body and facing wind, a tapered tail, and two side surfaces connected between the windward part and the tapered tail, the windward part is provided with a first wave structure, and the two side surfaces are provided with a second wave structure,
a hub, and
an aerodynamic rim, wherein the aerodynamic rim comprises an outer tire mounting part for mounting a tire, an inner spoke mounting part for mounting the multiple fiber spokes, and two rim side walls opposite each other between the outer tire mounting part and the inner spoke mounting part, wherein the hub is located at a center of the aerodynamic rim, a first end of each of the multiple fiber spokes is connected to the hub, and a second end of each of the multiple fiber spokes is connected to the inner spoke mounting part.

5. The wheel according to claim 4, wherein the aerodynamic rim comprises multiple aero profiles, and the multiple aero profiles are arranged on at least one of the two rim side walls and circumferentially surround a center point of the aerodynamic rim.

6. The wheel according to claim 5, wherein each of the multiple aero profiles has an outer contour in an inverted triangle shape, and the outer contour has a peak blade in a middle of the inverted triangle shape.

7. The wheel according to claim 6, wherein the peak blade is formed by a connection line between a vertex of the inverted triangle shape and a point on an opposing side of the vertex, and the opposing side is substantially parallel to an outer edge of one of the two rim side walls.

8. The wheel according to claim 6, wherein a surface of each of the multiple aero profiles is provided with at least partially overlapping layered staggered patterns.

9. The wheel according to claim 5, wherein each of the multiple aero profiles is formed by a combination of multiple dimple patterns, and at least one of the multiple dimple patterns is a teardrop dimple pattern.

10. The wheel according to claim 9, wherein each of the multiple aero profiles comprises a tapered head, an arc-shaped body, and a slender tail that are sequentially connected, and further comprises a fin extending outward from the arc-shaped body.
